(19) United States
(12) Patent Application Publication
(10) Pub. No.: US 2013/0047873 A1
(43) Pub. Date: Feb. 28, 2013

(54) RELEASE FLUID DELIVERY AND DAMPENING SYSTEM CLEANING METHODS, APPARATUS AND SYSTEMS FOR RADIATION CURABLE GEL INK PRINTING

(71) Applicants: Anthony S. CONDELLO, Webster, NY (US); Bryan J. Roof, Newark, NJ (US)

(72) Inventors: Anthony S. CONDELLO, Webster, NY (US); Bryan J. Roof, Newark, NJ (US)

(73) Assignee: XEROX CORPORATION, Norwalk, CT (US)

(21) Appl. No.: 13/223,047

(22) Filed: Aug. 31, 2011

(51) Int. Cl. B41L 25/06

(52) U.S. Cl. 101/147

(57) ABSTRACT

A dampening fluid delivery apparatus includes a water delivery line, a surfactant delivery line, and a cleaning solution delivery line, each connected to a mixing chamber. An open and closed state and a flow rate of one or more of the delivery lines may be controlled. Delivery lines may be pressurized and fitted with valves. The valves may be controlled using an electrically connected controller. The controller may control the dampening fluid delivery apparatus in accordance with at least one of print mode data and cleaning mode data.

### FIELD OF DISCLOSURE

The disclosure relates to dampening systems for radiation curable gel ink printing systems. In particular, the disclosure relates to dampening systems for delivering release agent and cleaning agent to a surface of a leveling roll of a radiation curable gel ink contact-leveling apparatus.

### BACKGROUND

Direct-to-substrate radiation curable gel ink printing is advantageous over related art ink printing such as solid and/or liquid ink printing. Like traditional fuser systems and solid ink transfix systems used in related art printing, radiation curable gel ink printing systems use contact-leveling nips to assist with spreading of ink deposited on media or a substrate such as paper.

Dampening systems are used to deliver release fluid to a spreading member such as a leveling roll of the contact-leveling nip. Gel ink systems run at or near room temperature, and silicone oils can interact with the gel inks. Accordingly, a water-based solution is used as a primary release agent. Water is combined with additives and applied in a thin, even layer on a surface of a leveling roll.

### SUMMARY

A dampening fluid having an exact ratio of water to additive, for example, such as a surfactant and/or defoamer, may be required based on a function of media, image characteristics, and/or system age to ensure good release fluid performance including good filming strength. It is desirable to accommodate control over fluid delivery to the dampening system so that a release fluid having a desired ratio of water to surfactant additive may be produced as required for a particular gel ink print run.

Further, a dampening system typically includes a roll train for delivering the release fluid to the leveling or spreading roll. It has been found that amounts of offset ink tend to migrate to the dampening roll train, which may subsequently lose acceptable functionality. Accordingly, it is desirable to accommodate delivery of a cleaning fluid to the dampening system. It is further desirable to accommodate control over the fluid delivery system so that a cleaning fluid having a desired ratio of water to cleaning solution may be produced as required for a particular cleaning job.

In an embodiment, dampening system fluid delivery methods may include delivering a desired amount of water to a mixing chamber; delivering one of a desired amount of surfactant and a desired amount of cleaning solution to the mixing chamber; combining the amount of water and the one of the amount of surfactant and the amount of cleaning solution in the mixing chamber; and delivering a mixture of the amount of water and the one of the amount of surfactant and the amount of cleaning solution combined in the mixing chamber to a dampening system.

In an embodiment, methods may include delivering an amount of water comprising controlling a flow of a water supply line, the water supply line being connected to the mixing chamber. Methods may include delivering an amount of surfactant comprising controlling a flow of a surfactant supply line, the surfactant supply line being connected to the mixing chamber. Methods may include delivering an amount of cleaning solution comprising controlling a flow of a cleaning solution supply line, the cleaning solution supply line being connected to the mixing chamber. Methods may include delivering the mixture combined in the mixing chamber comprising spraying the mixture on a surface of a dampening member of a dampening system.

In methods, the amount of water being delivered is based on one of input print data or input cleaning data. In methods, the amount of surfactant being delivered is based on input print data. In methods, the amount of cleaning solution being delivered is based on input cleaning data.

In an embodiment, apparatus may include a mixing chamber; and a plurality of fluid delivery lines, the plurality of fluid delivery lines including at least one of a surfactant delivery line and a water delivery line. Apparatus may include at least one fluid delivery output. The at least one fluid delivery output may be a nozzle configured to spray fluid onto a surface of a dampening member.

In an embodiment, the at least one surfactant delivery line may be configured to deliver a controlled amount of surfactant. The surfactant delivery line may include a control valve. In apparatus, the at least one water delivery line being configured to deliver a controlled amount of water, and may include a valve for control thereof. The plurality of fluid delivery lines may include a cleaning solution delivery line, the cleaning solution delivery line being configured for connecting to the mixing chamber. In an embodiment, the cleaning solution delivery line may include a control valve.

In an embodiment, the plurality of fluid delivery lines may be connected to a controller. The controller may be configured to control delivery line flow based on one of print mode data and cleaning mode data. Print and/or cleaning mode data may be stored in one or more memory modules, acquired from sensor, scanners, or the like, and/or input.

In an embodiment, systems may include a controlled fluid delivery line system for delivering a controlled amount of fluid; a fluid mixing system for receiving fluid delivered by the controlled fluid delivery system; and a dampening system comprising at least one dampening member, the dampening member being configured to receive fluid from the fluid mixing system. Systems may include the controlled fluid delivery line system further comprising a surfactant delivery line; a water delivery line; and a cleaning solution delivery line; at least one of the surfactant delivery line, the water delivery line, and the cleaning solution delivery line having a valve, the valve being configured for modulating a flow of the at least one line.

In an embodiment, systems may include a control system comprising a controller configured to control the delivery line system; and at least one memory module for storing at least one of print mode data and cleaning mode data. Systems may include a gel ink print system having a contact-leveling apparatus and/or a dampening system for providing release fluid to the contact-leveling apparatus.

Exemplary embodiments are described herein. It is envisioned, however, that any system that incorporates features of apparatus and systems described herein are encompassed by the scope and spirit of the exemplary embodiments.

### BRIEF DESCRIPTION OF THE DRAWINGS

FIG. 1 show a diagrammatic view of a dampening system fluid delivery system and a radiation curable gel ink printing system in accordance with an embodiment;

FIG. 2 shows a diagrammatical view of a dampening system fluid delivery system in accordance with an embodiment;

FIG. 3 shows a dampening system fluid delivery system print mode in accordance with methods of an embodiment;

FIG. 4 shows a dampening system fluid delivery system cleaning mode in accordance with methods of an embodiment.

### DETAILED DESCRIPTION

Exemplary embodiments are intended to cover all alternatives, modifications, and equivalents as may be included within the spirit and scope of the apparatus and systems as described herein. Reference is made to the drawings to accommodate understanding of methods, apparatus, and systems for delivering fluid to a dampening system of a radiation curable gel ink printing system. In the drawings, like reference to numerals are used throughout to designate similar or identical elements. Drawings depict various embodiments of illustrative methods, apparatus, and systems for delivering fluid to a dampening system of a radiation curable gel ink printing system.

Methods, apparatus, and systems of embodiments accommodate delivery of fluid such as release fluid for coating a surface of a contact-leveling member such as a drum or roll, which at least in part defines a contact-leveling or spreading nip in a radiation curable gel ink printing system. Methods, apparatus, and systems may be configured to deliver cleaning fluid for cleaning a dampening system.

Methods, apparatus, and systems accommodate on-demand mixing of specific amounts of components that comprise dampening system fluid prior to delivery to a dampening system. Individual, isolated, and pressurized fluid lines may be configured for carrying release fluid and/or cleaning fluid components to a pre-mixing region or mixing station. At the mixing station, the release fluid or cleaning fluid components may be mixed, and the resulting mixture may be delivered to the dampening system by way of, for example, one or more spray nozzles. The dampening fluid may be deposited onto a surface of a dampening roll using a spray nozzle fluid application system. Suitable dampening systems may include release fluid application systems and/or components thereof as disclosed in U.S. patent application Ser. No. 13/193,163 (APPARATUS AND METHOD FOR APPLYING RELEASE FLUID TO A LEVELER IN A PRINTING APPARATUS) and U.S. patent application Ser. No. 13/193,045 (APPARATUS AND METHOD FOR APPLYING RELEASE FLUID TO A LEVELER IN A PRINTING APPARATUS), the entire disclosures of which are incorporated by reference herein in their entirety.

In an embodiment, fluid delivery apparatus and systems may include one or more individual, isolated, and pressurized fluid lines, each dedicated to carrying and delivering particular fluid components. For example, a fluid delivery apparatus or system may include a first fluid delivery line for carrying water, a second fluid delivery line for carrying surfactant, and a third fluid delivery line for carrying cleaning solution. At least one of the one or more fluid delivery lines may be configured to open, close, and modulate fluid flow as function of what fluid(s) and amount(s) thereof may be required to produce a particular dampening fluid in accordance with a formulation appropriate for a particular print job and/or cleaning run.

In an embodiment of systems having one or more delivery lines configured for delivering release fluid components to a mixing chamber, the one or more delivery lines may be controlled to deliver a desired amount of water and/or a desired amount of surfactant. The fluid components may be pre-mixed before delivery in a mixing chamber to produce a release fluid comprising, e.g., a desired ratio of water to surfactant.

A dampening apparatus or system in a radiation curable gel ink printing system configured for delivering and applying a nominal and uniform layer of fluid to a surface of a nip forming member of a contact-leveling apparatus or system that contacts radiation curable gel ink to spread the ink on a substrate or media. The applied release fluid film functions as a sacrificial splitting layer. The release fluid is configured so that the forces required to split the film formed by the release fluid on a dampening system member are less than the forces required to cause the ink to separate from itself and/or the media or substrate on which the ink is deposited.

In an embodiment, release fluid or fountain solution may include a combination of water and surfactant, such as soap, polymer, or similar component. It is desirable to control an exact ratio of water to surfactant in order to achieve optimal release performance. Depending on a substrate type, a density of an image and/or an age of a system, high or lower surfactant concentrations may be desired for producing, e.g., a release fluid that accommodates formation of a film having appropriate strength. Also, because water readily evaporates when exposed to atmosphere, it is common for release solution to become more concentrated over time, thus resulting in less than ideal release performance.

A ratio of surfactant to water may be controlled by mixing the solution substantially immediately prior to delivering or applying release fluid onto a surface such as that of a dampening roll. For example, fluid from incoming surfactant and water delivery lines, respectively, may be merged at a mixing station, and an exact amount of flow for each line may be controlled to delivery desired amounts of water and/or surfactant. In an embodiment, precision control valves may be arranged upstream of a pressurized chamber wherein delivered surfactant and water may be mixed prior to delivery of the resulting mixture to a dampening system. For example, peristaltic pumps may be used for valve control of one or more fluid delivery lines.

In another embodiment, apparatus and systems may have one or more delivery lines configured for delivering cleaning fluid. Apparatus and systems may be configured for delivering cleaning fluid components to a mixing chamber for pre-mixing prior to delivery of the cleaning fluid to a dampening system. The one or more fluid delivery lines may be controlled to deliver a desired amount of water and/or cleaning solution to a mixing chamber to produce a cleaning fluid comprising, e.g., a desired ratio of water to cleaning solution. In another embodiment, systems may be configured to include one or more delivery lines for delivering both release fluid components and cleaning fluid components, and may be configured for delivering particular amounts and formulations of release fluid or cleaning fluid as needed.

A fluid delivery line may be configured for opening, closing, and/or modulating fluid flow. For example, one or more fluid delivery lines of a dampening fluid delivery apparatus or system may be configured with a valve or similar fluid gating apparatus for controlling fluid flow. A fluid delivery line may be pressurized and include a valve, which may be configured for control by an electrically connected controller. The controller may communicate with the valve to open and/or close the valve, and/or modulate fluid flow through the delivery line.

A suitable valve for use as a fluid gating apparatus in an exemplary embodiment may include a typical on/off solenoid. The solenoid may be pulsed at a high frequency or duty cycle to achieve desired results. An example of a typical on/off solenoid may include ELECTRO-MITE solenoid valves, such as a Series 2150 solenoid valve with flow control. In an alternative embodiment, the fluid gating apparatus may be fuel injector, such as suitably configured fuel injectors provided by BOSCH.

The fluid delivery lines may be composed of metal, polymer, or other material suitable for carrying water, surfactant, and/or cleaning solution. For example, a fluid delivery line may comprise copper, and/or chemically resistant polymer suitable for use with surfactant and/or cleaning solution and components thereof.

One or more controllers may be connected to one or more fluid delivery lines for controlling valve states and/or modulating fluid flow. The controller(s) may be configured to control the fluid delivery apparatus or system to produce dampening fluid of a particular type and/or formulation on demand and/or in accordance with a predetermined schedule, and/or as a response to a predetermined trigger or event.

In an embodiment, apparatus and system may be configured to run in a print mode wherein release fluid is produced and delivered to a dampening system. Depending on an age of system components, a type of substrate or media, an amount of desired coverage of the media with ink, and/or density of the ink image, a particular formulation of release fluid may be required for acceptable contact-leveling to spread the gel ink with minimal offset of the ink onto, for example, a contact-leveling roll of a contact-leveling nip. Such parameters may be determinative of a release fluid formulation to use for a particular print run, and data related to such parameters may be preset, user input, or based on sensor feedback. Formulations corresponding to particular conditions, or relating to particular parameters may be stored in a memory module. For example, fluid formulations and corresponding conditions and/or triggering parameters may be stored in a look-up table.

In an embodiment, apparatus and systems may be configured to run in a print mode on demand, based on sensor feedback, and/or in accordance with a schedule or routine. In a print mode, apparatus and system may be configured to control fluid delivery lines based on print run data. Print run data may be user input, predetermined, preprogrammed, and/or based on sensor feedback. Print run data may include information such as fluid formulations and/or corresponding conditions and/or triggering parameters, and may be communicated to and/or received by a fluid delivery system for control of fluid delivery lines to produce a desired fluid in a desired amount and/or in accordance with a desired formulation.

A release fluid formulation may comprise water and/or surfactant. An exemplary surfactant may comprise, for example, SILFSURF A008 by SILTECH. In a fluid delivery system configured for delivering a release fluid comprising water and surfactant, a first fluid delivery line for delivering water and a second delivery line for delivering surfactant may be used. The delivery lines may be connected to a mixing station such as a mixing chamber. The first and second fluid delivery lines may be controlled to deliver desired amounts of water and/or surfactant, respectively, to the mixing chamber as required for a desired release fluid formulation. The desired release fluid formulation, which may be determined based on parameters including system component age, substrate or media type, image density, and/or gel ink coverage of media, may be a formulation that accommodates delivery from a dampening onto a surface of a leveling member such as a leveling roll to form a thin film on the surface of the roll that constitutes an effective sacrificial splitting layer. For example, forces required to split the film may be less than forces required to cause the ink to separate from itself and/or the media on which the ink is spread at the leveling or spreading nip.

For example, a release formulation that is suitable for providing a sacrificial release layer in a gel ink printing system having a leveling apparatus with old rolls during a print run wherein gel ink is applied to a light weight media for covering a high percentage of an area of the media may include 97% water and 3% surfactant. In another example, to produce an acceptable print having a low percentage of gel ink area coverage on a heavy weight media using a gel ink printing system having a leveling apparatus with new rolls, a suitable release fluid formulation may require 99.5% water and 0.5% surfactant. In yet another example, to produce an acceptable print having a medium percentage of gel ink area coverage on Mylar media using a gel ink printing system having a leveling apparatus with new rolls, a suitable release fluid formulation may require 94% water and 6% surfactant. Formulations may be based on print run data that indicates system parameters, and/or print run data may comprise particular formulations. Formulations may be predetermined and stored in memory, and may be stored with corresponding conditions.

In an embodiment wherein a dampening fluid delivery apparatus is configured for delivering cleaning fluid to a dampening system for cleaning components of the dampening system, a dampening system fluid delivery apparatus or system may be configured to run in a cleaning mode. Dampening fluid delivery apparatus and systems may be configured to clean a dampening system of a gel ink printing system by delivering a cleaning fluid produced as required based on cleaning mode data; and/or producing a cleaning fluid in accordance with a formulation that is determined based on the cleaning mode data.

The cleaning mode data may be user input, predetermined or preprogrammed, and/or based on sensor feedback. For example, apparatus and systems may include a water delivery line and a separate cleaning solution delivery line that are configured for controlled delivery of cleaning fluid components to a mixing station. In an embodiment, the line(s) may be valve-controlled and pressurized, and the valves may be electrically connected to a controller. Based on cleaning mode data, apparatus and systems may be configured to deliver a particular amount of water and/or a particular amount of cleaning solution to a mixing chamber or station. The resulting cleaning fluid mixture may subsequently be delivered to the dampening system for cleaning as required for a particular cleaning job. The cleaning mode may be executed on demand, based on sensor feedback, and/or in accordance with a schedule. Contamination may be carried away with a sacrificial blank media or flushed to a waste container.

A dampening or oiling system may gradually accumulate ink and paper debris as a result of running high print volumes and/or stress documents. In methods, apparatus, and systems, water may be used to flush out and clean the dampening system. Because water alone may be insufficient, cleaning solution may be added to the water for effectively renewing the system. Cleaning may be performed on a routine schedule, or as needed. For example, a contamination sensor, such as a scanner or the like, may be used to initiate the cleaning cycle and confirm cleaning.

In an embodiment, to achieve effective cleaning, fluid delivery lines may be controlled to produce a cleaning fluid having a desired amount of water and/or surfactant. For example, apparatus and systems may include one or more individual valve-controlled delivery lines each for carrying one of water and cleaning solution. The delivery lines may carry the fluid to a mixing chamber for mixing prior to delivery to a dampening system. A cleaning fluid having a specific ratio of water to cleaning solution may be produced in accordance with a cleaning fluid formulation that is appropriate for a particular cleaning job. The formulations may be predetermined, and stored in a memory module.

Systems may be configured to control the fluid delivery lines to produce a cleaning fluid having a specific formulation when a corresponding particular condition is met or event occurs. Conditions and corresponding cleaning fluid formulations may be stored in a memory module. In an embodiment, a fluid delivery system may control fluid delivery lines to produce a cleaning fluid having a formulation that is appropriate for determined dampening system conditions based on cleaning mode data. Cleaning mode data may include printing system information such as component health, age, and material data; and/or cleaning mode data may include scheduling information and/or mixing or delivery routine information; and/or fluid formulation information relating to dampening fluids including release fluids and cleaning fluids.

Cleaning mode data may be stored in memory, and communicated to a controller that controls fluid delivery line(s) flow. The delivery lines may be controlled to produce a cleaning fluid having desired amounts of water and cleaning solution, e.g., a ratio of water to cleaning solution in accordance with a particular formulation. For example, a cleaning mode may be executed wherein cleaning mode data indicates that a dampening system includes old roll(s) that are dirty and require renewal, or the cleaning mode data indicates a formulation corresponding to such conditions. Accordingly, the fluid delivery system may control delivery lines to produce a cleaning fluid having 50% water to 50% Isopropyl Alcohol (IPA). Where a dampening system is determined to include new rolls, but requires refreshing before an important print job, the fluid delivery system may control fluid delivery lines to produce a cleaning fluid having 90% water to 10% IPA. Contamination may be carried away with sacrificial blank media and/or flushed to a waster container.

In an embodiment, a radiation gel ink printing system may be configured to run in both a print mode and a cleaning mode as desired. For example, a dampening fluid delivery system may include a plurality of delivery lines including a first delivery line for delivering water, a second delivery line for delivering surfactant, and a third delivery line for delivering cleaning solution. In a printing mode, surfactant may be mixed with water at the mixing station, and the resulting release fluid mixture may be delivered to the dampening system, for subsequent delivery to the contact-leveling or spreading apparatus of the radiation curable gel ink printing system. In a cleaning mode, cleaning agent or solution may be delivered alone to the mixing station, for subsequent delivery to the dampening system. The resulting cleaning solution mixture may be used for cleaning the dampening system. The fluid delivery lines may be pressurized, and may be opened and/or closed, and/or a flow of the delivery lines may be modulated using valves. A controller may be connected to the fluid delivery system, and may be configured to control the valves.

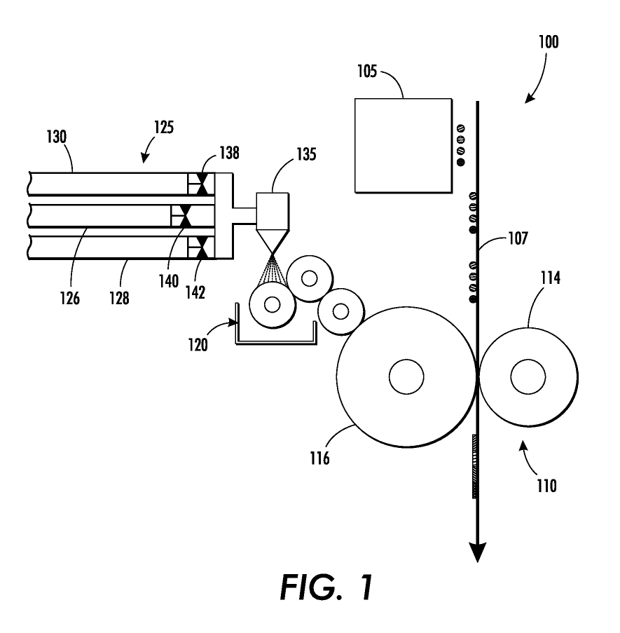

FIG. 1 shows a dampening fluid delivery apparatus and system in accordance with an exemplary embodiment. In particular, FIG. 1 shows a radiation curable gel ink printing system 100. The radiation curable gel ink printing system 100 may include an ink jet print head 105. The ink jet print head may be configured to deposit gel ink onto a substrate 107. The substrate 107 may carry the ink to a contact-leveling system 110. The contact-leveling system may be configured for spreading the gel ink on the substrate. For example, the contact-leveling system may include a pressure roll 114 and a spreader roll 116. The pressure roll 114 and spreader roll 116 may be arranged to define a contact-leveling nip at which pressure is applied to spread the ink on the substrate 107.

FIG. 1 shows a dampening system 120. A dampening system may include, for example, one or more dampening members such as rolls. The rolls may be arranged to form a roll train as shown. The rolls may be configured to carry dampening fluid such as release fluid or fountain solution, and/or cleaning solution to the contact-leveling apparatus 110.

The dampening system 120 may be configured to deliver and apply a nominal and uniform layer of fluid to a surface of the leveling member or spreader roll 116 of the contact-leveling apparatus 110. For example, release fluid or fountain solution may be delivered to the contact-leveling apparatus. The released fluid may comprise water and surfactant such as soap, polymer, or a similar surfactant. It is desirable to control an exact ratio of water to surfactant to achieve optimal release performance. Depending on a substrate type, density of an image and/or age of the system, a higher or lower surfactant concentration may be desired. Accordingly, a ratio of water to surfactant may be controlled by mixing the release fluid solution prior to spraying or otherwise delivering the release fluid to the dampening system 120.

Similarly, cleaning solution may be delivered to the dampening system 120 for cleaning the dampening system 120. The dampening system 120 may gradually accumulate ink and paper debris as a result of running high print volumes and/or stress documents. A cleaning fluid comprising water and/or cleaning solution may be delivered to the dampening system 120 for cleaning and renewing the system. Cleaning may be performed on a routine schedule, or as needed. A cleaning mode may be performed on demand. For example, a contamination scanner or a sensor may be used to initiate a cleaning cycle and confirm success thereof.

A dampening system fluid delivery system 125 is shown in FIG. 1. The dampening system fluid delivery system 125 may include a water delivery line 126, a surfactant concentrate delivery line 128, and a cleaning concentrate or cleaning solution delivery line 130. Each of the fluid delivery lines 126, 128, and 130 may be configured to communicate with an output such as jet 135. Jet 135 may be configured to deliver fluid to the dampening system 120. For example, Jet 135 may be configured to spray fountain solution or cleaning solution onto a dampening roll of a dampening system 120.

One or more of the fluid delivery lines may be controllable. For example, FIG. 1 shows the water delivery line 126, the surfactant delivery line 128, and the cleaning solution delivery line 130 being associated with valves 138, 140, and 142, respectively. Valves 138, 140, and 142 are control valves. The valves may be precision control valves. Peristaltic pumps may be arranged for controlling an amount of fluid delivered to a pressurized chamber that precedes a fluid delivery system output, e.g. jet 135. The delivery lines may also be pressurized.

Accordingly, the fluid delivery lines may be controlled so that particular amounts of fluid from each line may be added to a mixing chamber, and mixed therein before delivery to the dampening system 120. Valves 138, 140, and 142 may be connected to a controller that controls the valves based on data that is input, based on sensor feedback, and/or predetermined. For example, the valves may be controlled based on print run data and/or cleaning mode data. Print run data may relate to system component age, substrate properties, and print job parameters such as percent area coverage of substrate. Valves 138, 140, and 142 may be controlled based on cleaning mode data. Apparatus and systems may be configured to optionally run in a print run mode and/or cleaning mode.

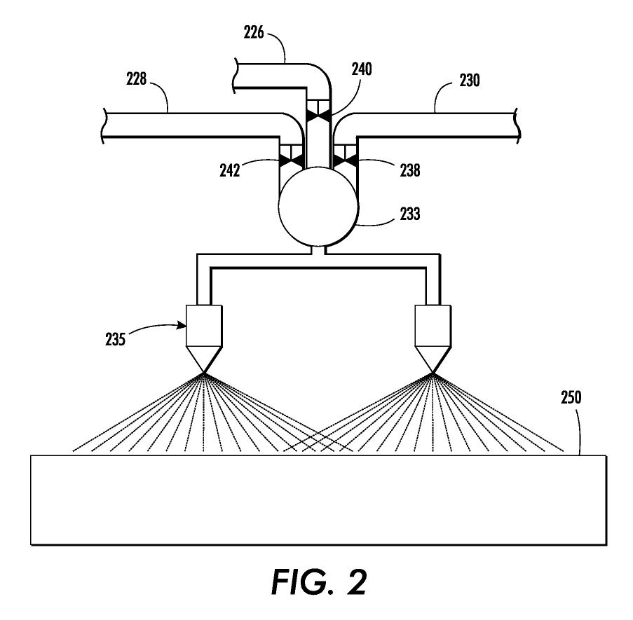

FIG. 2 shows a dampening fluid delivery apparatus in accordance with an exemplary embodiment. In particular, FIG. 2 shows a water delivery line 226, a surfactant concentrate delivery line 228, and a cleaning concentrate or cleaning solution delivery line 230. The water delivery line 226 may be configured to deliver water to a mixing chamber 233. The surfactant concentrate delivery line 228 may be configured to deliver surfactant concentrate to the mixing chamber 233. The cleaning concentrate delivery line 230 may be configured to deliver cleaning concentrate to the mixing chamber 233. Valves may be used to control when water, cleaning concentrate, and/or surfactant concentrate are added to the mixing chamber 233, and amounts thereof. The valves may be controlled to open and/or close the delivery line(s), and/or modulate a flow of the delivery line(s).

For example, surfactant and water may be mixed in the mixing chamber 233 to produce release fluid or fountain solution for delivery to a dampening system. Valves 240 and 242 may be used to control an amount of water and surfactant concentrate, respectively, delivered to the mixing chamber 233. Accordingly, after the release fluid mixture is produced at the mixing chamber 233, the mixture may be delivered to the dampening system by, for example, spraying the release fluid from one or more jets 235 onto a dampening roll 250. The ratio of water to surfactant concentrate in the fountain solution mixture may be determined based on print run data. The water and surfactant concentrate delivery and mixing, and subsequent delivery of fountain solution to the dampening system, e.g. dampening roll 250, may be run in accordance with the print run data in a print run mode. Particular formulations of release fluid may be stored in memory for retrieval in response to instructions, commands, and/or predetermined conditions. Print run data my include information related to conditions, commands, and/or corresponding fluid formulations.

In an embodiment of apparatus and systems, the water delivery line 226, and/or the cleaning concentrate delivery line 230 may be used to delivery water and/or cleaning concentrate to mixing chamber 233. The resulting cleaning solution may be delivered to the dampening system. For example, the cleaning solution may be delivered by way of jets 235 to a dampening roll 250 of a dampening system. Valves 238 and 240 may be used to control when fluid is delivered from the water delivery line 226 and cleaning concentrate delivery line 230, respectively. Further, valves 238 and 240 may be used to control an amount of fluid delivered from each of the water delivery line 226 and cleaning concentrate delivery line 230. Accordingly, a desired ratio of water to cleaning concentrate may be mixed in the mixing chamber 233 prior to delivery to the dampening system.

Cleaning solution may be produced and delivered to the dampening system based on cleaning data, which may include information related to system conditions, system components, print run parameters, conditions, commands, and/or corresponding cleaning fluid formulations. For example, apparatus and systems may be configured to run in a cleaning mode wherein cleaning solution is produced and delivered based on cleaning data such as data that is input or predetermined. For example, a contamination sensor or scanner may be used to initiate the cleaning mode and confirm success of the cleaning mode. Systems may be configured to include and perform both a print run mode and cleaning mode wherein release fluid and/or cleaning solution having particular ratios of water to surfactant concentrate, or, e.g. water to cleaning concentrate based on print run data and/or cleaning mode data, respectively.

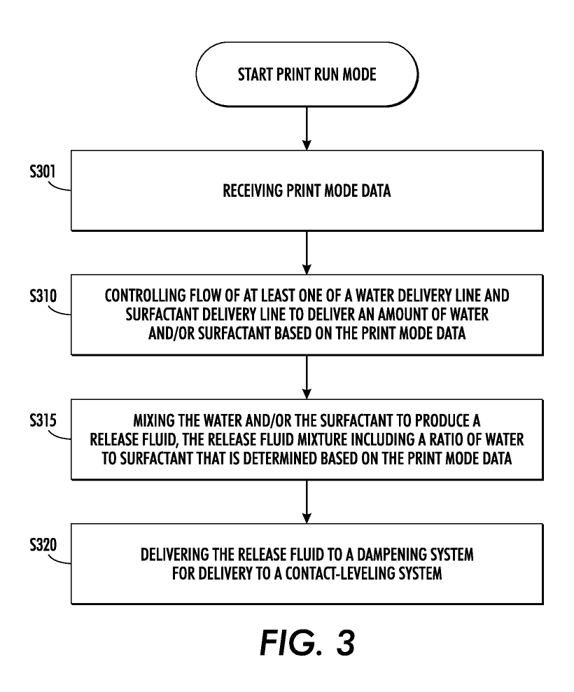

FIG. 3 shows methods in accordance with an exemplary embodiment. For example, systems may be configured to run in a print run mode as shown in FIG. 3. A print mode may be initiated on demand, in response to a command or event, and/or in accordance with a present routine or schedule. Dampening system fluid delivery methods may include receiving print mode data at S301. Print mode data may be input by a user, or predetermined and stored in memory. Alternatively, print mode data may be acquired by sensors or the like. Print mode data may include data related to substrate or media type to be printed on in a print job, system component age, wear, and contamination, and print job parameters such as percent area coverage of ink on media or a substrate.

Based on the print mode data, fluid delivery lines may be controlled to produce a release fluid for delivery to a contact-leveling or spreading system of a gel ink printing system. At S310, a flow of at least one of a water delivery line and a surfactant concentrate delivery line may be controlled to deliver a desired amount of water and/or surfactant. The amount of water and/or surfactant may be based on the received print run or print mode data.

The amount of water and/or surfactant may be delivered to a mixing station or device. For example, the water and the surfactant may be mixed at S315 to produce a release fluid mixture. The mixture may include a ratio of water to surfactant that is determined based on the print mode data received at S301. For example, the print mode data may reflect a system in which the contact-leveling apparatus includes old rolls. The print mode data may also reflect that the media to be used in the print job is lightweight, and that high percentage area coverage is to be achieved during the print job. Accordingly, by way of S310 and S315, a release fluid mixture of 97% water and 3% surfactant may be produced. The mixture may be delivered at S320 to a dampening system for subsequent delivery to the contact-leveling system for effectively spreading radiation curable gel ink.

In another example, print mode data may relate to a system having new rolls, a print job in which heavyweight media is to be used and low percent area coverage is to be achieved. Accordingly, by way of S310 and S315, a release fluid mixture of 99.5% water to 0.5% surfactant may be produced. This mixture may be delivered to the contact-spreading system at S320. In another example, the print mode data may relate to a system having new rolls, Mylar, and medium percent area coverage to be achieved. Accordingly, the water and surfactant delivery lines may be controlled at S310 to deliver an amount of water and surfactant based on the input data to produce a mixture S315 having 94% water to 6% surfactant. The print mode data may include system information and/or fluid formulation information. This resulting release fluid mixture may be delivered to the dampening system at S320.

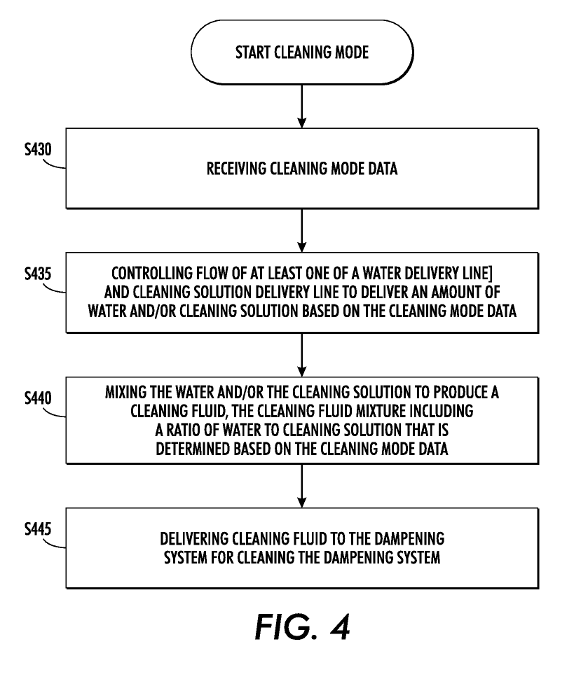

Dampening fluid delivery apparatus and systems in accordance with the embodiments may be configured to run in a cleaning mode as shown in FIG. 4. FIG. 4 shows an exemplary embodiment of a cleaning mode in accordance with methods. A cleaning mode may be initiated on demand, in response to sensor feedback, in response to a command, satisfaction of a condition or occurrence of an event, and/or in accordance with a routine or schedule. Methods may include executing a cleaning mode in accordance with cleaning mode data. For example, cleaning mode data may be received at S430. Cleaning mode data may be input or predetermined. Cleaning mode data may be related to a preset routine or schedule. Alternatively, cleaning mode data may relate to data received from a scanner or sensor configured to detect levels of condition in a dampening system, initiate the cleaning cycle, and confirm success thereof.

At S435, one or more of isolated water delivery line and cleaning solution delivery lines may be controlled deliver a desired amount of water and/or cleaning solution based on the cleaning mode data received at S430. For example, a flow of at least one of a water delivery line and a cleaning solution delivery line may be controlled to deliver a desired amount of water and/or cleaning solution to a mixing station for subsequent delivery to a dampening system.

The desired amount of water and/or cleaning solution may be mixed at the mixing station at S440. The resulting cleaning fluid mixture includes a ratio of water to cleaning solution in accordance with a desired ration determined based on the cleaning mode data received at S430.

By way of example, cleaning mode data may reflect a dampening system in which the dampening members are old rolls that are dirty and need renewal. Accordingly, a flow of the water delivery line and/or cleaning solution delivery line may be controlled based on the cleaning mode data to deliver an appropriate amount of water and cleaning solution to a mixing chamber for producing a cleaning solution mixture according to a particular formulation. Such a formulation may have, for example, a ratio of 50% water to 50% IPA. The mixture produced in S440 includes a ratio of water and cleaning solution that is determined based on the cleaning mode data. The mixture may be delivered to the dampening system 445.

By way of another example, the cleaning mode data received at S430 may relate to a system new rolls that require refreshing before an important printout. Accordingly, the water delivery line and cleaning solution delivery line controlled at S435 to deliver an amount of water and an amount of cleaning solution to the mixing chamber produce cleaning fluid mixture having a ration of 90% water to 10% IPA at S440. The resulting mixture may be delivered to the dampening system at S435. In another embodiment, cleaning mode data may include cleaning fluid formulation information. The formulation information may be determined based on input and/or detected system conditions and/or print parameters.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. A dampening system fluid delivery method, comprising:
delivering a desired amount of water to a mixing chamber;
delivering one of a desired amount of surfactant and a desired amount of cleaning solution to the mixing chamber;
combining the amount of water and the one of the amount of surfactant and the amount of cleaning solution in the mixing chamber; and
delivering a mixture of the amount of water and the one of the amount of surfactant and the amount of cleaning solution combined in the mixing chamber to a dampening system.

2. The system of claim 1, the delivering an amount of water comprising controlling a flow of a water supply line, the water supply line being connected to the mixing chamber.

3. The system of claim 1, the delivering an amount of surfactant comprising controlling a flow of a surfactant supply line, the surfactant supply line being connected to the mixing chamber.

4. The system of claim 1, the delivering an amount of cleaning solution comprising controlling a flow of a cleaning solution supply line, the cleaning solution supply line being connected to the mixing chamber.

5. The system of claim 1, the delivering the mixture combined in the mixing chamber comprising spraying the mixture on a surface of a dampening member of a dampening system.

6. The system of claim 1, wherein the amount of water being delivered is based on one of input print data or input cleaning data.

7. The system of claim 1, wherein the amount of surfactant being delivered is based on input print data.

8. The system of claim 1, wherein the amount of cleaning solution being delivered is based on input cleaning data.

9. A dampening system fluid delivery apparatus comprising:
a mixing chamber; and
a plurality of fluid delivery lines, the plurality of fluid delivery lines including at least one of a surfactant delivery line and a water delivery line.

10. The apparatus of claim 9, comprising:
at least one fluid delivery output.

11. The apparatus of claim 10, wherein the at least one fluid delivery output is a nozzle configured to spray fluid onto a surface of a dampening member.

12. The apparatus of claim 9, the at least one surfactant delivery line being configured to deliver a controlled amount of surfactant.

13. The apparatus of claim 12, the surfactant delivery line further comprising a control valve.

14. The apparatus of claim 10, the at least one water delivery line being configured to deliver a controlled amount of water.

15. The apparatus of claim 9, the plurality of fluid delivery lines further comprising:
a cleaning solution delivery line, the cleaning delivery line being configured for connecting to the mixing chamber.

16. The apparatus of claim 15, the cleaning solution delivery line further comprising a control valve.

17. The apparatus of claim 9, the plurality of fluid delivery lines being connected to a controller, the controller being configured to control delivery line flow based on one of print mode data and cleaning mode data.

18. A dampening fluid delivery system, comprising:
a controlled fluid delivery line system for delivering a controlled amount of fluid;
a fluid mixing system for receiving fluid delivered by the controlled fluid delivery system; and
a dampening system comprising at least one dampening member, the dampening member being configured to receive fluid from the fluid mixing system.

19. The dampening fluid delivery system of claim 18, the controlled fluid delivery line system further comprising:
a surfactant delivery line;
a water delivery line; and
a cleaning solution delivery line; at least one of the surfactant delivery line, the water delivery line, and the cleaning solution delivery line having a valve, the valve being configured for modulating a flow of the at least one line.

20. The system of claim 19, comprising:
a control system comprising a controller configured to control the delivery line system; and at least one memory module for storing at least one of print mode data and cleaning mode data.
